(19) United States
(12) Patent Application Publication
(10) Pub. No.: US 2010/0095763 A1
(43) Pub. Date: Apr. 22, 2010

(54) TEMPERATURE COMPENSATED DENSITY SENSING PROCESS AND DEVICE

(75) Inventor: James Jeffrey Harris, Cameron Park, CA (US)

Correspondence Address: DUBOIS, BRYANT, CAMPBELL & SCHWARTZ, LLP, 700 LAVACA STREET, SUITE 1300, AUSTIN, TX, 78701, US

(73) Assignee: INTEVRAS TECHNOLOGIES, LLC, Austin, TX (US)

(21) Appl. No.: 12/559,998

(22) Filed: Sep. 15, 2009

Related U.S. Application Data
(60) Provisional application No. 61/097,046, filed on Sep. 15, 2008.

(51) Int. Cl. G01N 9/00

(52) U.S. Cl. 73/32 R

(57) ABSTRACT

A total dissolved solids measurement process and device are provided that facilitates total dissolved solids sensing of a subject fluid via relative buoyancy levels of separate float bodies; one buoyed by the subject fluid of varying total dissolved solids and temperatures and another buoyed by a reference fluid of constant total dissolved solids but of a varying temperature matching the subject fluid. The equal temperature baths of the subject fluid and the reference fluid as well as geometrical shape and weighting of the floats conveys the total dissolved solids as the difference in buoyancy levels of the floats. This difference in buoyancy levels is of further benefit for activation of sundry controls.

### CROSS-REFERENCE TO RELATED APPLICATIONS

This non-provisional application claims priority based upon prior U.S. Provisional Patent Application Ser. No. 61/097,046 filed Sep. 15, 2008 in the name of James Jeffrey Harris, entitled “Specific Gravity Switch,” the disclosure of which is incorporated in its entirety by this reference as if fully set forth herein.

### BACKGROUND OF THE INVENTION

The present invention concerns density-based sensing of total dissolved solids (TDS) of a fluid; especially those fluids wherein the density varies both due to TDS and temperature. The prior art primarily employs one of three methods for sensing the TDS of fluids; electric resistance, nuclear properties or density-based methods. The density-based approach is the simplest and most economical.

Density methods require temperature corrections to accurately relate density measurements to TDS values. The prior art employs various means for such corrections; some corrections are simply performed via an independent temperature measurement and graphical or manual conversion from the sensed density and measured temperature to obtain a usable TDS value. Other methods, inclusive of this invention, automatically compensate for temperature effects to obtain a usable TDS value. The invention provides superior accuracy, simplicity and lower cost when compared to the methods of the prior art.

U.S. Pat. No. 2,296,169 teaches buoyant floats employing bi-metallic indicators. The bi-metallic indicators compensate for temperature by thermally distorting, reflective of the temperature effects. This approach is accurate only over small temperature ranges and is susceptible to failure due to electrolysis or corrosion of the bimetallic component. Further, the design of the bimetallic strip is unique for the specific fluid under investigation. As a result, this method of the prior art will generally not be accurate for different fluids.

Another approach, disclosed in U.S. Pat. Nos. 4,136,551, 3,980,467 and 4,037,481, employs buoyant floats made of materials with similar thermal expansion characteristic as the fluid under investigation. This approach is accurate only over small temperature ranges due to the difficulty of accurately matching the thermal properties of solid and liquid materials. Further, the float material of choice for one fluid generally will not be applicable for another fluid, limiting the applicability of this approach.

The invention is not hindered by the foregoing burdens of the prior art. In some embodiments, the invention employs a reference fluid, such as oil with minimal solubility for solids, thereby purveying an unchangeable density due to TDS. Use of a reference fluid has been previously employed such as the Westphal-Mohr balance method/apparatus for accurate, batch density/specific gravity measurement wherein both the reference fluid and the subject fluid are measured at a specific temperature. This method of the prior art employs the use of a reference fluid via series, batch analytical comparison of the reference fluid to the subject fluid. In substantial contrast, especially for process control concerns, the invention employs parallel, continuous analysis specifically focused to minimize thermal effects and maximize TDS effects on the subject fluid density; facilitating TDS sensing as directly indicated by buoyancy-defined density.

### BRIEF SUMMARY OF THE INVENTION

The present invention is directed towards a density sensing process and device which provides the facility to sense a fluid density while compensating via simple mechanical/hydraulic means for variation in the fluid temperature. In one embodiment, the invention measures density/specific gravity as indicative of the total dissolved solids (TDS) content of the subject fluid. In contrast to the prior art, the invention does not require complicated electronics or other external means to sense the TDS while compensating for temperature effects. The sensing device is comprised of at least two buoyant floats buoyed in two fluids; one float being buoyed in the subject fluid, the other float being buoyed in a reference fluid. The density of the subject fluid being established by TDS as well as by temperature. The reference fluid is so chosen as having a base level, steady concentration of TDS as well as conveying a density that is also temperature sensitive. Accordingly, the buoyancy experienced by the float in the subject fluid is purveyed by both the TDS as well as the temperature of the subject fluid. In contrast, the buoyancy experienced by the float in the reference fluid is purveyed only by the temperature since the reference fluid maintains a steady base TDS level. By maintaining the temperature of the reference fluid equivalent to that of the subject fluid any relative change in the float levels in the two fluids can be correlated as a change in density corresponding only to the change of TDS.

In one embodiment, the invention employs floats that are geometrically configured and weighted so that both floats rise and fall concurrently with temperature change; any deviance between the rise or sink levels of the floats therefore can only be a consequence of density change in the subject fluid due to variation of the TDS. This embodiment conveys simple monitoring, switching and other process control benefits to the invention pursuant to float elevation indicated TDS changes of the subject fluid.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a frontal schematic of a density sensing device wherein two cylindrical floats are adjacently buoyed in two separated fluids, one being the reference fluid and the other being the fluid subject to TDS investigation;

FIG. 2 is a frontal view of a density sensing device inclusive of a viewable measurement scale to reflect the subject fluid TDS;

FIG. 3 is a frontal view of a density sensing device inclusive of an activation switch for facilitating process control when the TDS of the subject fluid increases to a maximum amount;

FIG. 4 is a frontal view of a density sensing device inclusive of an activation switch for facilitating process control when the TDS of the subject fluid decreases to a minimum amount;

FIG. 5 is a frontal view of a density sensing device inclusive of a viewable temperature scale to directly reflect the reference fluid temperature and indirectly the subject fluid temperature;

FIG. 6 is a frontal view of a density sensing device inclusive of thermal activation switches for process temperature control reflective of high and/or low temperature setpoints;

FIG. 7 is a frontal view of an embodiment of the invention wherein two temperature compensating flotation bodies are buoyed in the reference fluid on two opposite sides of a central TDS measurement flotation body buoyed in the subject fluid;

FIG. 8 is an isometric view of an embodiment of the invention wherein two temperature compensating flotation bodies are buoyed in the reference fluid on two opposite sides of a central TDS measurement flotation body buoyed in the subject fluid;

FIG. 9 demonstrates an isometric view of an embodiment of the invention wherein a thermal compensation flotation body is circumferentially buoyed in the reference fluid which surrounds a central cylinder containing the subject fluid; and

FIG. 10 demonstrates an isometric view of an embodiment of the invention wherein a thermal compensation flotation body is circumferentially buoyed in the reference fluid which surrounds a central cylinder containing the subject fluid.

### DETAILED DESCRIPTION

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention. The present invention will be described with respect to preferred embodiments in a specific context, namely as a device and process for TDS measurement and process control based on the density/specific gravity of a fluid with potentially varying TDS as well as temperature. The invention may also be applied, however, to other situations wherein density/specific gravity measurement/control issues are advantageous.

The device of the present invention employs buoyancy phenomenon to reflect the TDS via density of a subject fluid. The phenomenon is often referred to as the Archimedes principle; wherein a body is lifted in a fluid bath by a force equal to the weight of the fluid displaced by the body. The fact that a body will float due to a force lifting upwards equivalent to the weight of the volume of fluid displaced and the fact that the weight of the body itself places a counter-posing sinking effect on the body drives the body to float in an equilibrium position in the fluid wherein the rising and sinking forces are in equilibrium; the effect is that the more dense (higher TDS) the fluid, the higher the body will float. Conceptually, by simply knowing the geometric shape (volume) and weight of the body submerged in the fluid, the density (and corresponding TDS) of the fluid can be indicated by the level of submersion of the body in the subject fluid. This simple concept is complicated by the fact that most fluids at a given TDS level will exhibit substantial density variation due to thermal expansion/contraction of the fluid. As a consequence, although the floating level does reflect the fluid density, this density is not itself a reflection of the TDS but rather also a reflection of the fluid temperature.

The device of the present invention purveys the simple floatation level method for measuring TDS by compensating for temperature effects with the flotation of one or more separate thermal compensating float bodies in reference fluid baths and a measurement float supported in a separate subject fluid bath.

The geometry and weight of the thermal compensating float bodies are configured so that density variations generated by temperature change of the reference fluid cause similar lifting or sinking of the thermal compensating float bodies as is experienced by the measurement float in the subject fluid maintained at a constant TDS but exposed to the same temperature variation as the reference fluid. Since both the reference floats and the measurement floats move equally with temperature change, any rising or falling of the measurement float in excess or less than the motion of the thermal compensating floats represents density changes conveyed specifically by increases or decreases, respectively of the TDS of the subject fluid.

The device orchestrates these effects by employing thermal compensating floats and associated reference fluids in proximity to the measurement float and associated subject fluid wherein the subject and reference fluids are maintained at the same temperature. Variation in the height of the measurement float relative to the thermal float(s) is a direct, measurable and useful result of changes of TDS in the subject fluid.

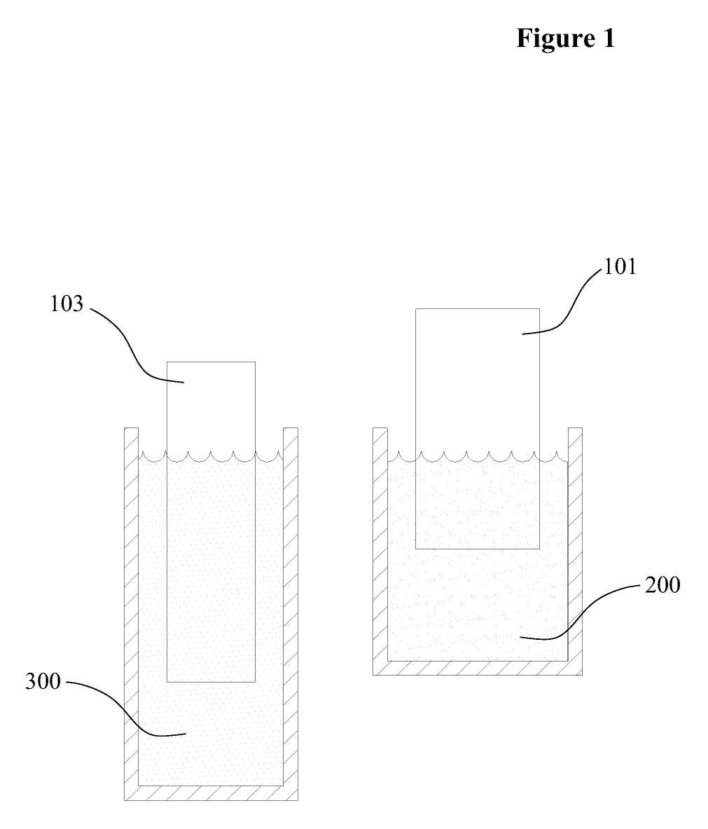

With reference now to FIG. 1, the device of the present invention employs two floats, a measurement flotation body 101 and a thermal compensation flotation body 103. These two bodies are separately placed in two baths; the measurement flotation body 101 in a subject fluid 200 and the thermal compensation body in a reference fluid 300. The subject fluid 200 varies in both TDS and temperature, while the reference fluid 300 is at a constant TDS but varies in temperature but of equal temperature to the subject fluid 200. As the temperature changes in both the subject bath 200 and the reference bath 300, the buoyed level of both the measurement flotation body 101 and the thermal compensation flotation body 103 rise in parallel. As the TDS changes, however, in the subject bath 200, the buoyed level of the measurement flotation body 101 changes relative to the buoyed level of the thermal compensation flotation body 103. Specifically as illustrated on FIG. 1, an increase of the TDS of the subject fluid 200 results in a rise of the buoyed level of the measurement flotation body 101 relative to the thermal compensation flotation body 103.

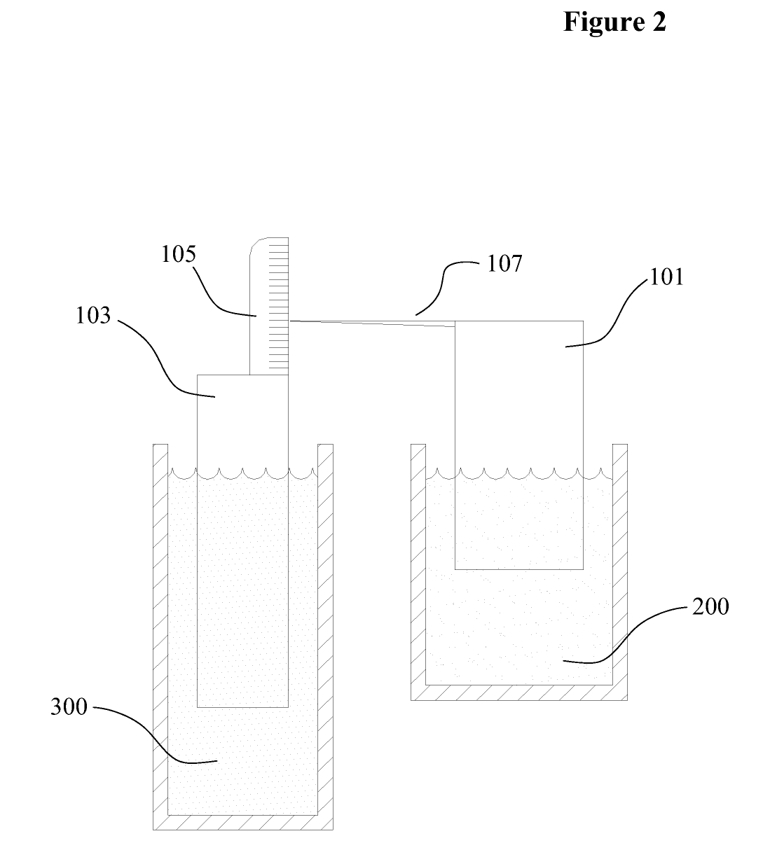

FIG. 2 illustrates one embodiment of the invention which includes a relative TDS measurement system incorporating a tabulation 105 attached to the thermal compensation flotation body 103 and an indicator arm 107 attached to the measurement flotation body 101. Note that the placement of tabulation 105 on thermal compensation flotation body 103 rather than on measurement flotation body 101 and the placement of indicator arm 107 on measurement flotation body 101 rather than thermal compensation flotation body 103 is immaterial since the indicating motions are relative. Temperature change in the subject fluid 200 and the corresponding temperature change in the reference fluid 300 result in equal buoyed level changes for the measurement flotation body 101 and the thermal compensation flotation body 103. Equal thermally driven motions of the measurement flotation body 101 with the attached indicator arm 107 relative to the tabulation 105 attached to the thermal compensation flotation body 103 demonstrate no TDS change resulting from the temperature change. However a change of TDS in the subject fluid 200 results in a change of buoyancy level of the measurement flotation body 101 relative to the thermal compensation flotation body 103 resulting in motion of the indicator arm 107 relative to the tabulation 105 thereby indicating a TDS change in the subject fluid 200. Specifically as illustrated on FIG. 2, an increase of the TDS of the subject fluid 200 results in a rise of the buoyed level of the measurement flotation body 101 and corresponding indicator arm 107 relative to the thermal compensation flotation body 103 and the corresponding tabulation 105.

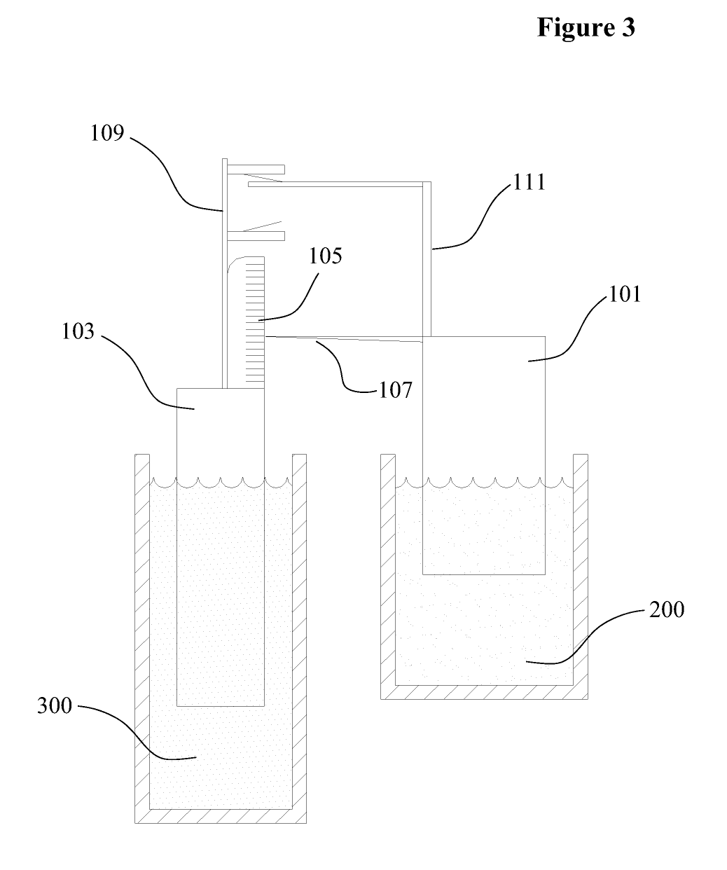

FIG. 3 illustrates another embodiment of the present invention which includes a relative TDS control device activation system. This embodiment employs a switch control shaft and switches 109 attached to the thermal compensation flotation body 103 and a switch activator arm 111 attached to the measurement flotation body 101. Note that the placement of switch control shaft and switches 109 on thermal compensation flotation body 103 rather than on measurement flotation body 101 and the placement of switch activator arm 111 on measurement flotation body 101 rather than thermal compensation flotation body 103 is immaterial since the indicating motions are relative. Temperature change in the subject fluid 200 and the corresponding temperature change in the reference fluid 300 result in equal buoyed level changes for the measurement flotation body 101 and the thermal compensation flotation body 103. Equal thermally driven buoyant motions of the measurement flotation body 101 with the attached switch activator arm 111 relative to the switch control shaft 109 attached to the thermal compensation flotation body 103 demonstrate no buoyed elevation changes resulting from the temperature change and accordingly no activation of the control devices resulting from contact between the switch control shaft 109 and the switch activator arm 111. However a change of TDS in the subject fluid 200 results in a change of buoyancy level of the measurement flotation body 101 relative to the thermal compensation flotation body 103 resulting in motion of the switch activator arm 111 relative to the switch control shaft 109 thereby initiating a control response associated with a TDS change in the subject fluid 200. Specifically as illustrated on FIG. 3, an increase of the TDS of the subject fluid 200 results in a rise of the buoyed level of the measurement flotation body 101 and corresponding switch actuator arm 111 relative to the thermal compensation flotation body 103 and the corresponding switch control shaft 109. The resulting contact with between the switch control shaft 109 and the switch activator arm 111 provides a signal for high TDS dependent control.

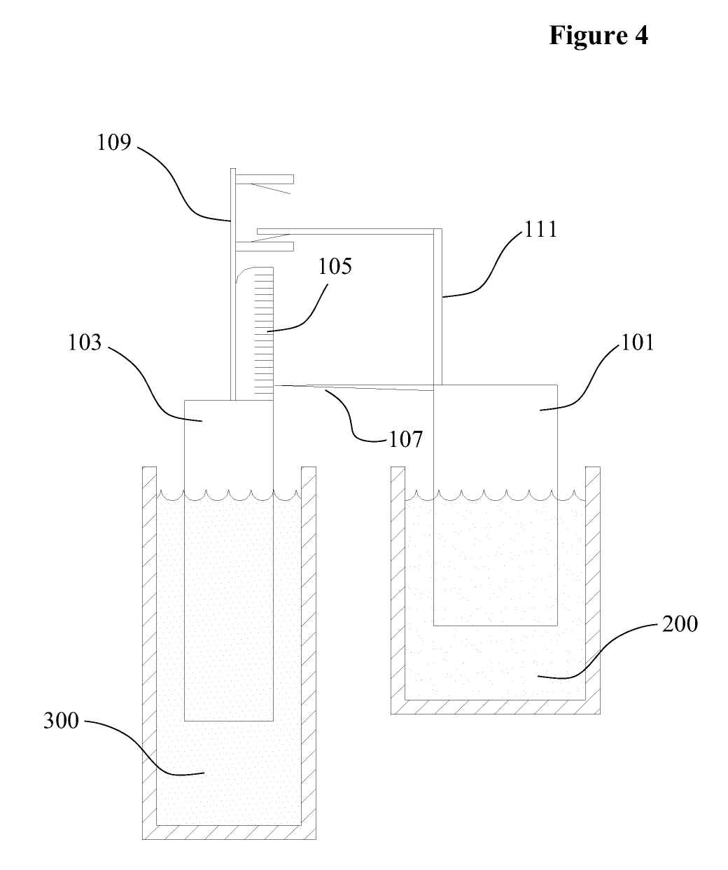

FIG. 4 illustrates an embodiment of the present invention wherein switch activator arm 111 comes in contact with the lower switch on switch control shaft 109 causing the device to indicate low TDS dependent control.

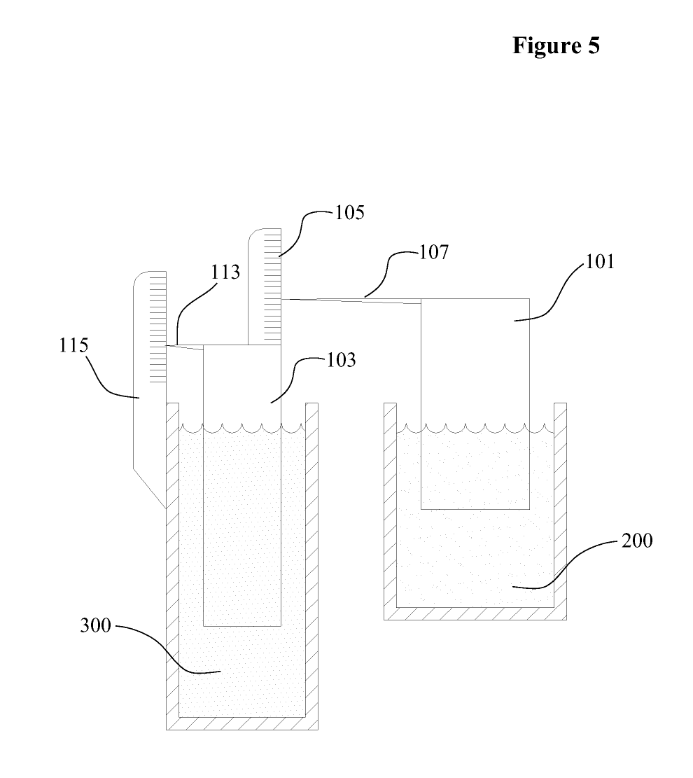

FIG. 5 illustrates an embodiment of the invention that includes a temperature indicating capability by incorporating a temperature indicating arm 113 attached to the thermal compensation flotation body 103 and a temperature tabulation 115 attached to a rigid mount external to the thermal compensation flotation body 103. In this embodiment, in addition to the TDS tabulation, the motion of the thermal compensation flotation body 103 and associated temperature indicating arm 113 relative to the temperature tabulation 115 defines the temperature of the reference fluid 300 and subject fluid 200.

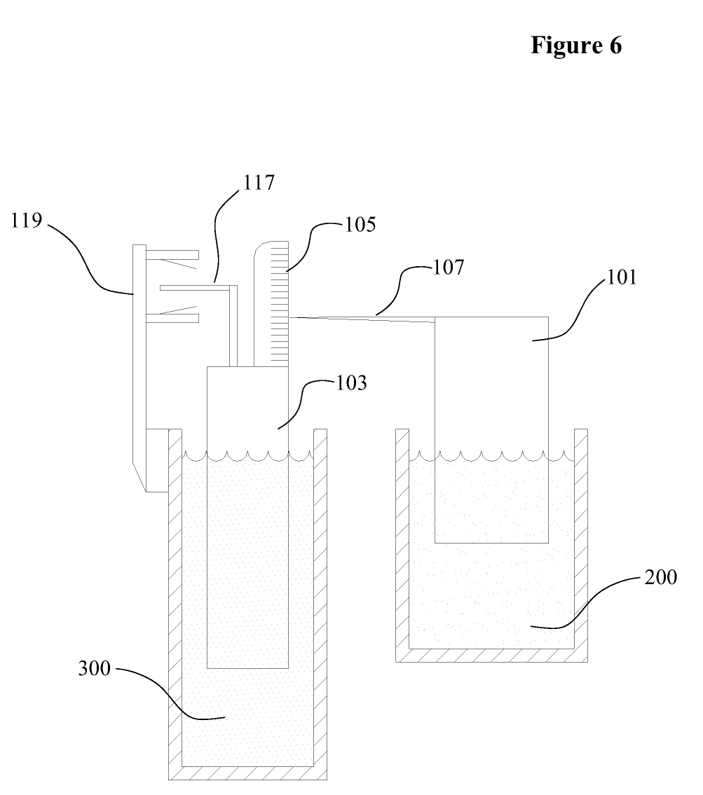

FIG. 6 illustrates an embodiment of the invention that includes a temperature control activating switch capability by incorporating a temperature switch activating arm 117 attached to the thermal compensation flotation body 103 and a temperature switch support frame with switches 119 attached to a rigid mount external to the thermal compensation flotation body 103. In this embodiment, in addition to the TDS tabulation, the motion of the thermal compensation flotation body 103 and associated temperature switch activating arm 117 relative to the temperature switch support frame 119 provides the invention with the additional benefit of signal generation for subject fluid high and/or low temperature dependent setpoint controls.

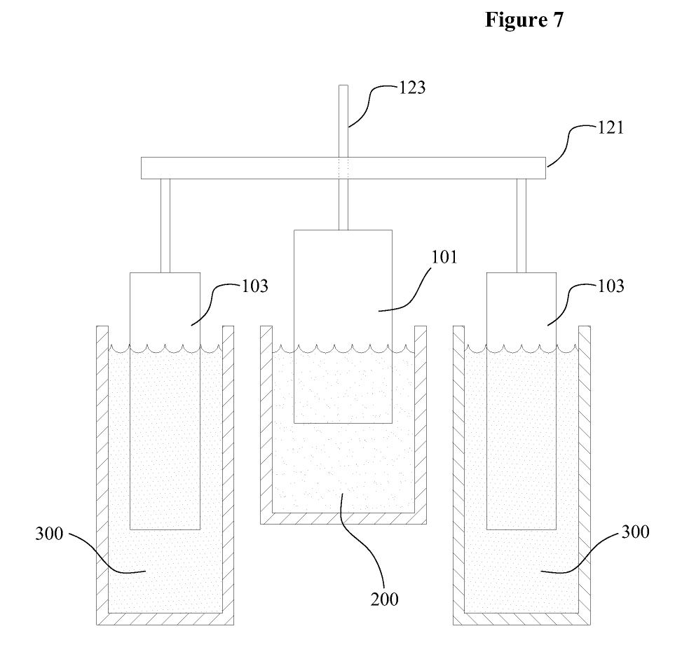

FIG. 7 illustrates an embodiment of the present invention that incorporates two thermal compensation flotation bodies 103 and one measurement compensation body 101. The two thermal compensation flotation bodies 103 are supported in two reference fluid baths 300 adjacent to but on opposite sides of a measurement flotation body and associated subject fluid 200 bath. A rigid thermal compensation bar 121 attaches the two thermal flotation bodies 103 together on opposite sides of the measurement flotation body 101. A TDS measurement shaft 123 is attached to the upper center of the measurement flotation body 101 and passes through a hole in the thermal compensation bar 121. As in the previous figures reference baths 300 and the subject fluid bath 200 are at the same temperature. TDS changes in the subject fluid 200 bath results in relative motion of the TDS measurement shaft 123 through the thermal compensation bar 121. The TDS is defined by the length of extension or retraction of the measurement shaft 123 through the thermal compensation shaft 121.

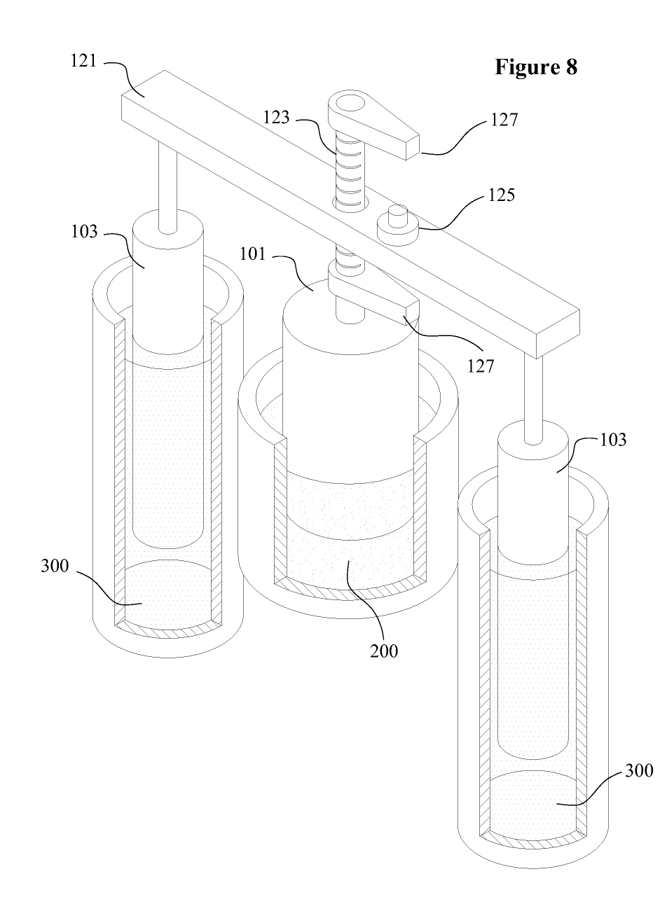

FIG. 8 further includes contact switches 125 attached to the thermal compensation bar 121 wherein switch contact levers 127 are attached to the TDS measurement shaft 123. The switch contact levers 127 make signaling contact with the contact switches 125 to signal high and/or low TDS dependent setpoint outputs. Because the relative motion of the thermal compensation bar 121 is relative to the measurement shaft 123, the placement of the contact switches 125 on the thermal compensation bar 121 and the switch contact levers 127 on the measurement shaft can be readily reversed.

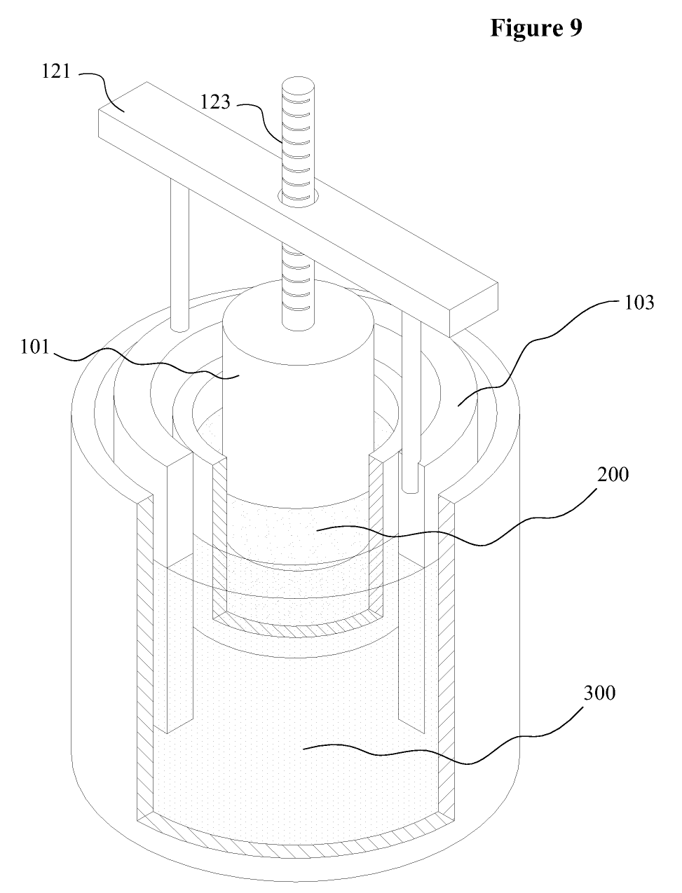

FIG. 9 illustrates an embodiment of the invention in which a ring shaped body of reference fluid 300 buoys a ring shaped thermal compensation flotation body 103 circumferentially about a central measurement flotation body 101 buoyed in the subject fluid 200. A thermal compensation bar 121 extends across the thermal compensation flotation body 103. A TDS measurement shaft 123 extends upward from the central measurement flotation body passing through the thermal compensation bar 121. TDS changes in the subject fluid 200 buoy the central measurement flotation body 101 and associated TDS measurement shaft 123 upward or downward with the relative position of the measurement shaft 123 passing through the thermal compensation bar 121 defining the subject fluid 200 TDS. As a consequence of the relative motion effects, the ring shaped thermal compensation flotation body 103 and the central measurement flotation body 101 can be exchanged for each other.

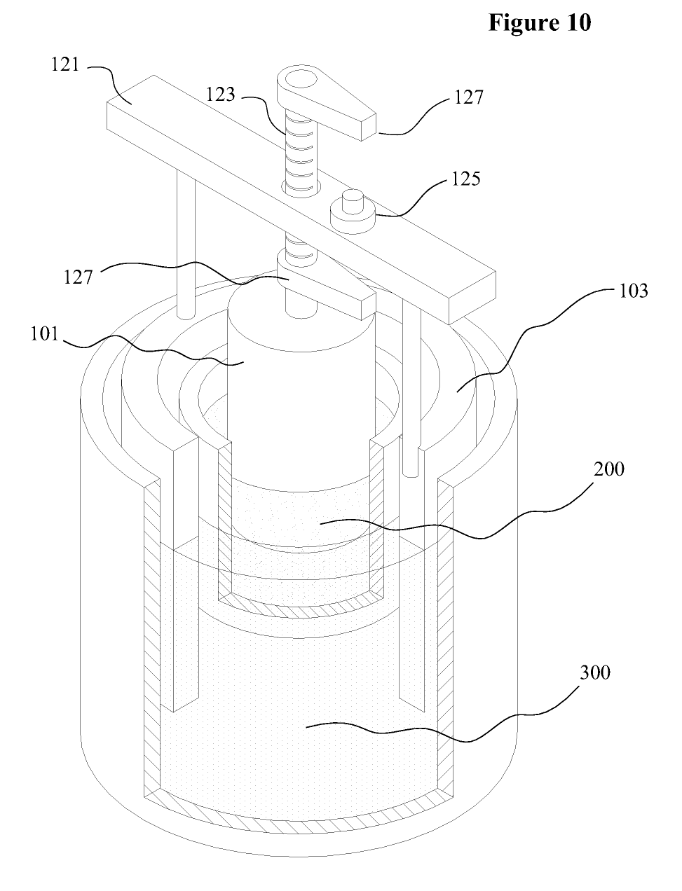

FIG. 10 further includes contact switches 125 attached to the thermal compensation bar 121 and switch contact levers 127 are attached to the measurement shaft 123. The switch contact levers 127 make signaling contact with the contact switches 125 to signal high and/or low TDS dependent setpoint outputs. As a consequence of the relative motion effects, the ring shaped thermal compensation flotation body 103 and the central measurement flotation body 101 can be exchanged for each other.

One novel feature of the device and process of the present invention is the employ of a reference fluid, which in the preferred embodiment is a type of oil with known thermal expansion characteristics. Further, this reference fluid of the preferred embodiment has no solubility for mineral salts, the primary TDS constituent of the subject fluids of the preferred embodiment. Accordingly, any change of density experienced by the thermal reference fluid can only be a result of temperature change. Consequently, any changes in subject fluid float buoyancy greater or less than changes experienced by the thermal reference float buoyancy can only be a result of TDS driven density changes in the subject fluid.

Another novel feature of the device and process of the present invention is that, for indicative/measurement purposes, external power sources are not required. Indeed the invention can be employed without any external energy to present indications/measurements of the density/specific gravity of most types of fluids. This is an attractive benefit to remote sites. This benefit reduces operating costs, improves reliability and provides what would otherwise be unavailable service.

Another novel feature of the device and process of the present invention is its simplicity. Elimination of complicated/sophisticated temperature compensating density measurement instruments reduces capital cost, improves reliability, reduces training requirements of employees as well as reduces maintenance time and expense.

Another novel feature of the device and process of the present invention is that the inherent simplicity of the invention eliminates the need for special types of materials. Indeed, for most applications inexpensive, readily available and non-corrosive plastics can be easily employed. This benefits the capital cost, repair expense, reliability as well as deliverability of maintenance items.

Another novel feature of the device and process of the present invention is that it eliminates the plugging and scaling potential often suffered by the prior art. The device operates from low flow to no flow conditions, eliminating the need for orifices, and other tight locations prone to plugging problems. As a consequence, the device provides continuous, maintenance free service.

Another novel feature of the device and process of the present invention is the flexibility for the employ of differing thermal reference fluids. Different reference fluid properties are managed by simple geometry and weighting changes of the thermal floats.

Another novel feature of the device and process of the present invention is the ability for the invention to also provide temperature indications and associated temperature control features.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps. Finally, in the foregoing discussion and in the claims, the terms “including” and “comprising” are used in an open-ended fashion, and thus should be interpreted to mean “including, but not limited to . . . ”.

What is claimed is:

1. A process for measuring total dissolved solids comprising:
a. a measurement flotation body in a subject fluid bath of varying total dissolved solids and varying temperature;
b. a thermal compensation flotation body in a reference fluid bath of constant total dissolved solids and varying temperature;
c. wherein the subject fluid bath and the reference fluid bath are at similar temperatures; and
d. wherein relative flotation levels of the measurement flotation body and the thermal compensation flotation body define total dissolved solids in the subject fluid.

2. The device of claim 1 wherein relative motion indicators of the measurement flotation body and the thermal compensation flotation body provide indications of total dissolved solids.

3. The device of claim 1 wherein relative motion of the measurement flotation body relative to the thermal compensation flotation body activates control devices.

4. The device of claim 1 wherein motion of the thermal compensation flotation body defines the temperature of the subject fluid bath and the reference fluid bath.

5. The device of claim 1 wherein motion of the thermal compensation flotation body activates control devices.

6. The device of claim 1 wherein the subject fluid bath is varying.

7. The device of claim 1 wherein the reference fluid bath is varying.

8. A total dissolved solids measurement process comprising:
a. a measurement flotation body in a subject fluid bath of varying total dissolved solids and varying temperature;
b. a plurality of connected thermal compensation flotation bodies in a reference fluid bath of constant total dissolved solids and varying temperature;
c. wherein the subject fluid bath and the reference fluid bath are at similar temperatures; and
d. wherein relative flotation levels of the measurement flotation body and the thermal compensation flotation bodies define the total dissolved solids of the subject fluid bath.

9. The device of claim 8 wherein two or more attached thermal compensation floatation bodies surround a centralized measurement flotation body.

10. The device of claim 8 wherein relative motion indicators of the measurement flotation body and the thermal compensation flotation bodies provide indications of total dissolved solids in the subject reference bath.

11. The device of claim 8 wherein relative motion of the measurement flotation body relative to the thermal compensation flotation bodies activates control devices.

12. The device of claim 8 wherein motion of the thermal compensation flotation bodies defines the temperature of the subject reference bath and the reference fluid bath.

13. The device of claim 8 wherein motion of the thermal compensation flotation bodies activates control devices.

14. The device of claim 8 wherein the subject fluid bath is varying.

15. The device of claim 8 wherein the reference fluid bath is varying.

16. A total dissolved solids measurement process comprising:
a. a measurement flotation body in a subject fluid bath of varying total dissolved solids and varying temperature;
b. a thermal compensation flotation body and reference fluid bath of constant total dissolved solids and varying temperature circumferentially surrounding the subject fluid bath;
c. wherein the subject fluid bath and the reference fluid bath are at similar temperatures;
d. wherein relative flotation levels of the measurement flotation body and the thermal compensation flotation bodies define the total dissolved solids of the subject fluid bath.

17. The device of claim 16 wherein relative motion indicators of the measurement flotation body and the thermal compensation flotation body provide indications of total dissolved solids in the subject fluid bath.

18. The device of claim 16 wherein relative motion of the measurement flotation body relative to the thermal compensation flotation body activates control devices.

19. The device of claim 16 wherein motion of the thermal compensation flotation body defines the temperature of the subject fluid bath and the reference fluid bath.

20. The device of claim 16 wherein motion of the thermal compensation flotation body activates control devices.

21. The device of claim 16 wherein the subject fluid bath is varying.

22. The device of claim 16 wherein the reference fluid bath is varying.

23. A total dissolved solids measurement process comprising:
a. a thermal compensation flotation body in a reference fluid bath of constant total dissolved solids and varying temperature;
b. a measurement flotation body in a subject fluid bath of varying total dissolved solids and varying temperature circumferentially surrounding the reference fluid bath;
c. wherein the subject fluid bath and the reference fluid bath are at similar temperatures;
d. wherein the relative flotation levels of the measurement flotation body and the thermal compensation flotation bodies define the total dissolved solids of the subject fluid bath.

24. The device of claim 23 wherein relative motion indicators of the measurement flotation body and the thermal compensation flotation body provide indications of total dissolved solids of the subject fluid bath.

25. The device of claim 23 wherein relative motion of the measurement flotation body relative to the thermal compensation flotation body activates control devices.

26. The device of claim 23 wherein motion of the thermal compensation flotation body defines the temperature of the subject fluid bath and the reference fluid bath.

27. The device of claim 23 wherein motion of the thermal compensation flotation body activates control devices.

28. The device of claim 23 wherein relative motion indicators of the measurement flotation body and the thermal compensation flotation body provide indications of total dissolved solids in the subject fluid bath.

29. The device of claim 23 wherein the subject fluid bath is varying.

30. The device of claim 23 wherein the reference fluid bath is varying.
